(19) United States
(12) Patent Application Publication
(10) Pub. No.: US 2003/0106349 A1
(43) Pub. Date: Jun. 12, 2003

(54) Locking apparatus

(76) Inventors: Alan Clive Broadbridge, Warwickshire (GB); Neil David Broadbridge, Warwickshire (GB); Clive Beardmore, West Midlands (GB); Brian Thomas Birch, West Midlands (GB)

Correspondence Address: Deepak Malhotra, Wells St John Roberts Gregory & Matkin, Suite 1300, 601 West First Avenue, Spokane, WA, 99201-3817, US

(21) Appl. No.: 10/149,855

(22) PCT Filed: Dec. 12, 2000
(86) PCT No.: PCT/GB00/04724

(30) Foreign Application Priority Data
Dec. 15, 1999 (GB) 9929706.1

(51) Int. Cl. E05B 73/00

(52) U.S. Cl. 70/58

(57) ABSTRACT

A security lock for a computer having a wall (42) with a rectangular or circular hole (43; 44) therethrough comprises a body (11) to which a security cable (16) is secured, the body having a push button lock (18) therein, activation of the lock causing a pair of retention arms (24) to move linearly apart against spring means (35; 50). The arms have hook-like terminal portions (33) at the exterior of the body (11) and activation of the lock after the portions (33) have been passed through the hole (43; 44) causes the arms to move apart so that the portions (33) locate “behind” the hole, thereby securing the security lock to the computer. The security lock has is body (11) secured against rotation relative to the lock (18), with the body and lock being freely rotatable relative to the retention arms.

This invention relates to a security lock principally intended for use with computer equipment, particularly laptop computers, to prevent the theft thereof.

Laptop computers are commonly manufactured with a rectangular security slot into which can be fitted a locking security device, which is anchored to an immovable object, normally by means of a steel cable. Known such security devices lock to the computer by a crossmember hooking behind the slot at right angles to the length of the slot. This method of anchorage is not as secure as anchoring at the ends of the slot and may allow the crossmember to be pulled out. Another disadvantage of this type of device is that the crossmember is secured by it being turned through 90° once it has passed through the slot. It is thus important to ensure that any part of the device, for example the locking means, which is connected to the crossmember, cannot be gripped and turned so as to allow unauthorised rotation of the crossmember back through 90°, to release the locking of the device. This requirement can result in the device being of complex construction, with many component parts, and thus being relatively expensive to produce.

An object of the invention is to provide locking apparatus in an effective and convenient form.

According to a first aspect of the present invention there is provided a locking apparatus comprising a housing, locking means at least partly within the housing and secured thereto for angular movement therewith, retention means extending at least partly from the housing and being movable by operation of the locking means from a retracted state to an extended state, the arrangement being such that, in use; at least part of the retention means in said retracted state can be passed through an opening in an element, and the locking means then operated to move the retention means to said extended state, in which state the apparatus is attached to said element, and said housing and locking means are angularly movable together relative to said retention means.

The invention will now be described, by way of example, with reference to the accompanying drawings, in which:

FIGS. 1 and 2 are perspective views showing opposite ends respectively of a locking apparatus of the invention in its unlocked state,

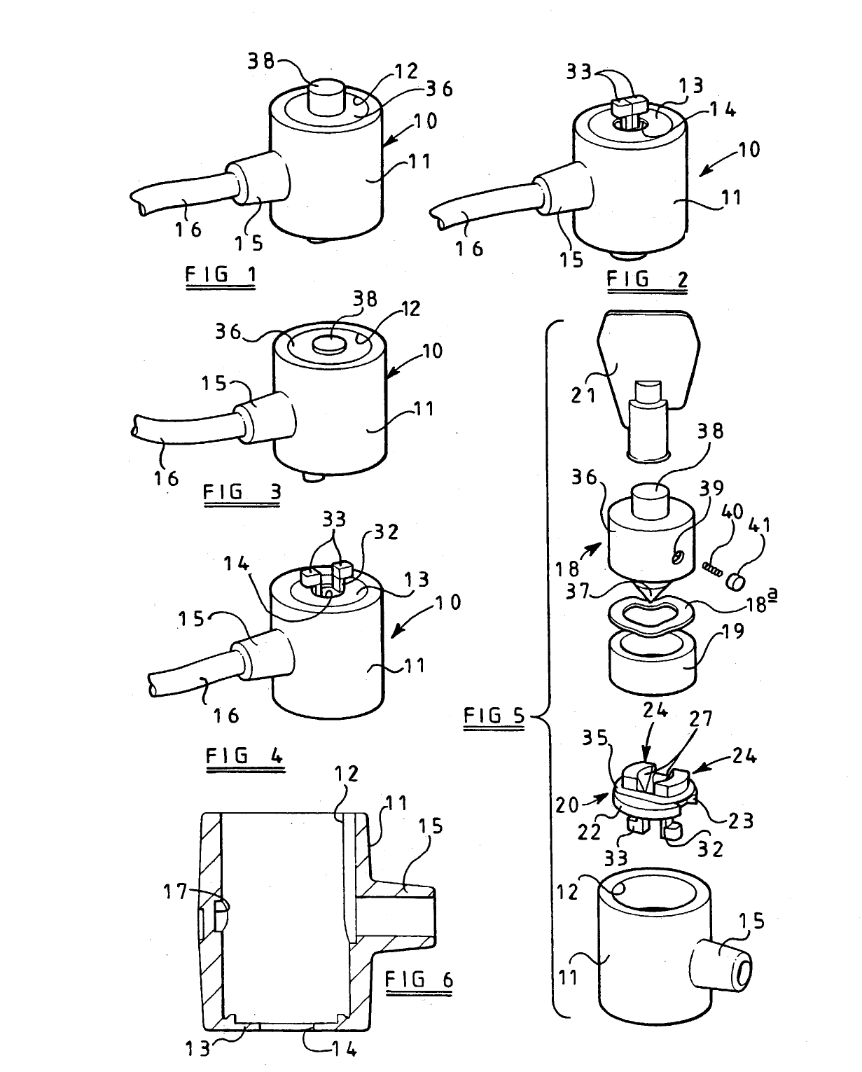

FIGS. 3 and 4 are views corresponding to FIGS. 1 and 2 respectively, but showing the locking apparatus in its locked state,

FIG. 5 is an exploded view of the locking apparatus of FIGS. 1 to 4, with an operating key also being shown,

FIG. 6 is a cross-sectional view of a body of the locking apparatus,

FIG. 7 is an enlarged plan view of a guide of the locking apparatus,

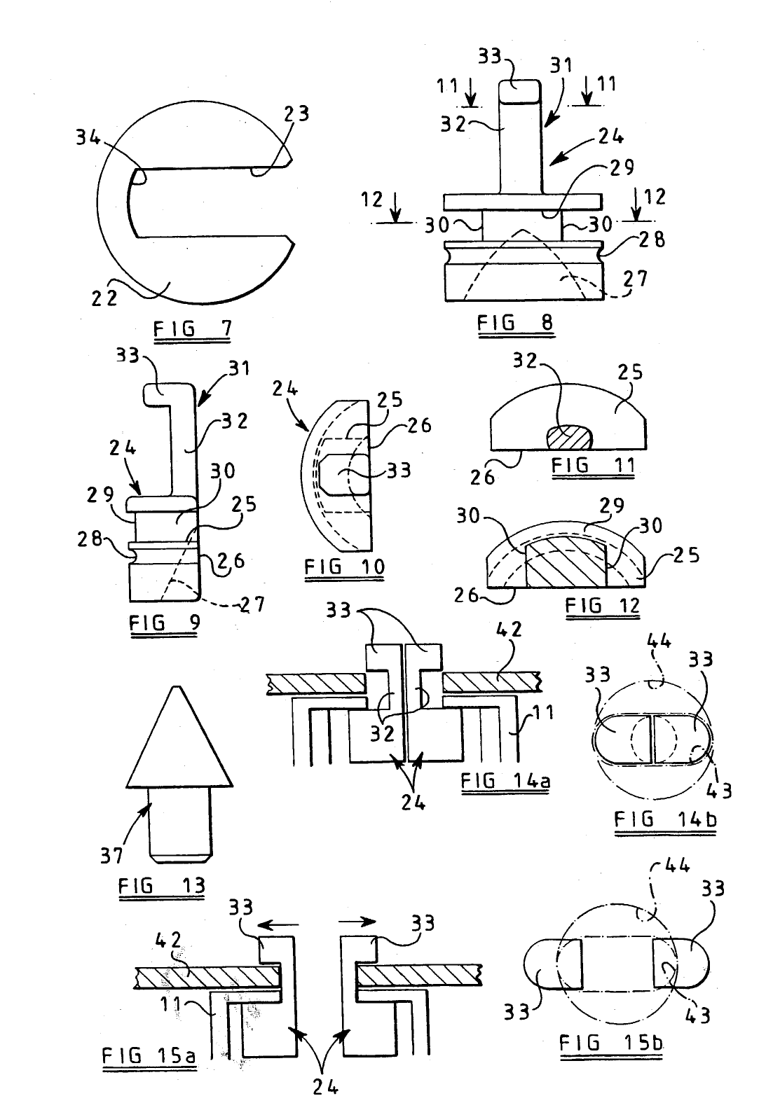

FIGS. 8 to 10 are respectively a front view, a side view and an end view of an arm of retention means of the locking apparatus,

FIGS. 11 and 12 respectively are cross-sectional views on the lines 11-11 and 12-12 of FIG. 8,

FIG. 13 is a side view of part of locking means of the locking apparatus,

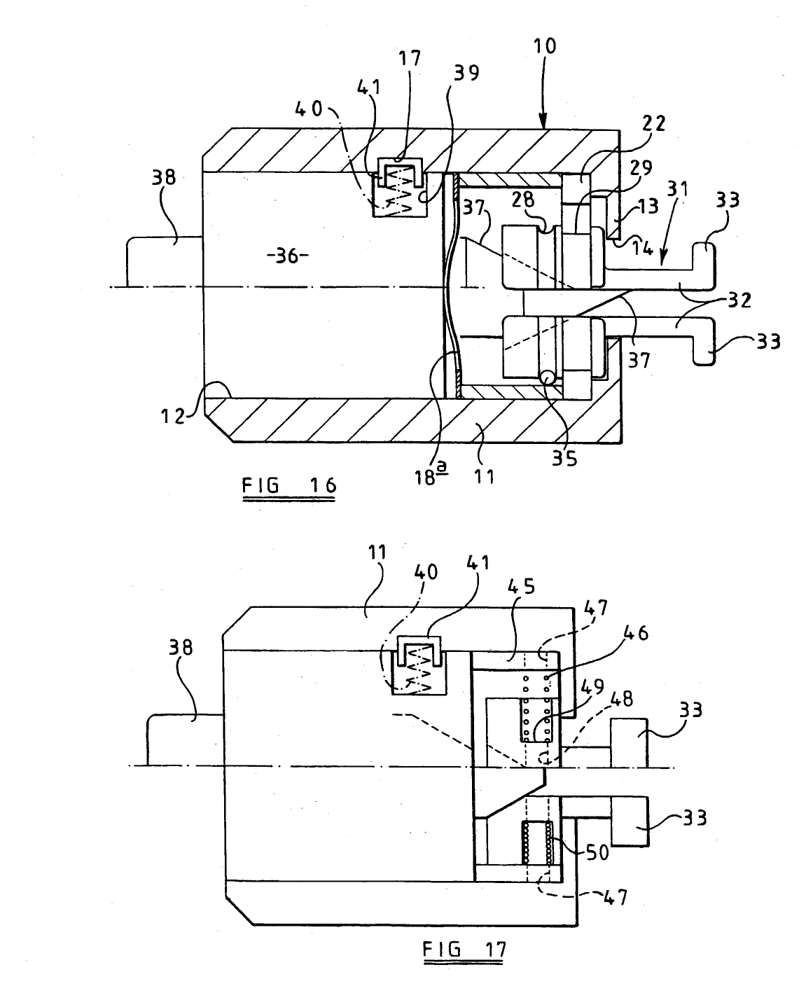

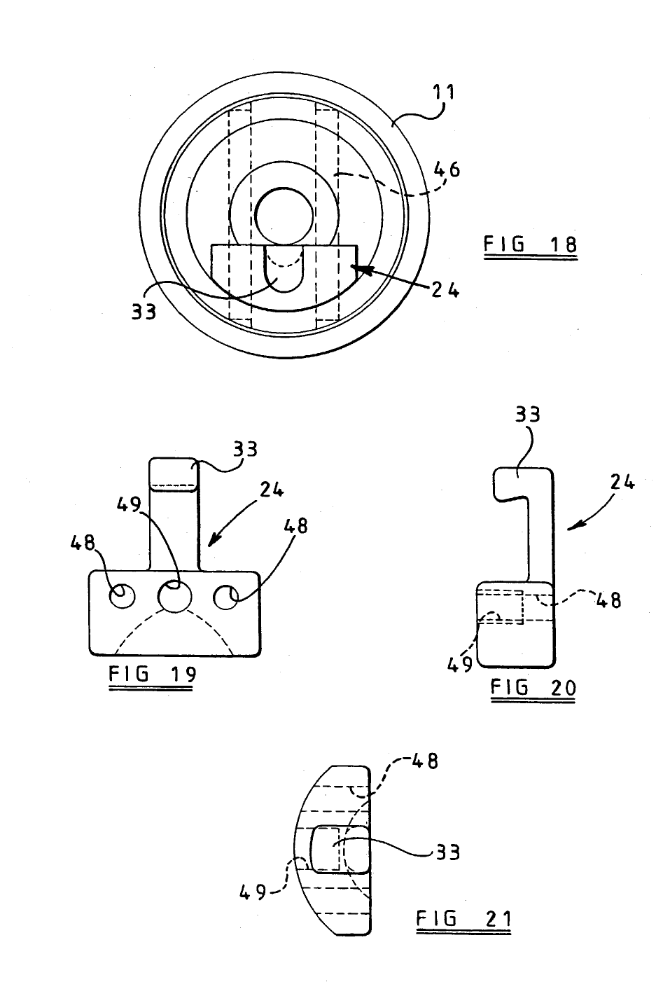

FIG. 14a is a schematic part-sectional view showing the locking apparatus fitted at an opening in an element before locking is effected,

FIG. 14b is a schematic end view showing the disposition of arms of the locking apparatus in the unlocked state as in FIG. 14a in both a circular opening and a rectangular slot,

FIGS. 15a and 15b respectively correspond to FIGS. 14a and 14b for the locked state of the locking apparatus,

FIG. 16 is an enlarged cross-sectional partial view of the locking apparatus with one half depicting its unlocked state and the other half depicting its locked state,

FIG. 17 is a schematic view corresponding to FIG. 16 for another embodiment of a locking apparatus of the invention,

FIG. 18 is an end view of the locking apparatus of FIG. 17, but with only the locked disposition shown,

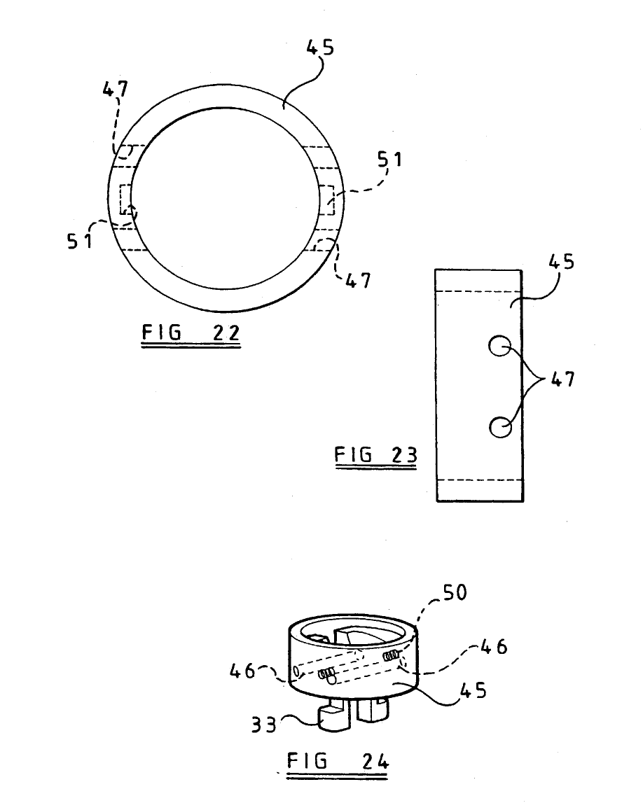

FIGS. 19 to 21 respectively are a front view, a side view and an end view of an arm of retention means of the locking apparatus of FIG. 17, and

FIGS. 22 and 23 are respectively an end view and a side view of a bush of the locking apparatus of FIG. 17.

The locking device 10 shown generally in FIGS. 1 to 5, has a metallic generally cylindrical outer body or housing 11, shown in detail in FIG. 6. The body 11 is fully open at 12 at one of its ends, whilst an end wall 13 at the opposite end is provided with a central small circular hole 14. If desired, a foam pad (not shown) can be affixed to the outer surface of end wall 13, with a hole corresponding to and aligned with the hole 14 extending through said foam pad, this foam serving, in use, as will be described, to engage a surface of the computer or other device to be protected by the locking apparatus of the invention. At approximately half way along its length, the external surface of the body 11 is formed with an integral generally radially outwardly projecting hollow spigot 15 into which, in use, a steel cable 16 is secured, the cable serving, in use, in a conventional manner to be anchored to an immovable object thereby to secure the computer or other device to which the locking apparatus is attached, in use, as will be described. The internal surface of the body 11 at a position generally diametrically opposite the bore through the hollow spigot 15, is formed with a cylindrical recess 17 for a purpose to be described.

As shown in FIGS. 1 to 5, the body 11, which comprises one component of the locking apparatus, receives four further basic components thereof, these being locking means 18, a wavy washer 18a, a spacer 19, and a retention assembly 20. Also shown in FIG. 5 is a key 21 for releasing the locking means 18 from a locked condition.

FIG. 7 shows a guide of the retention assembly 20, this being in the form of a C-shaped washer 22 which defines a central slot 23 which is open at one end. Carried by this guide for sliding movement along said slot 23, towards and away from one another, are a pair of arms 24, shown in detail in FIGS. 8 to 12. Whilst the washer 22 could be made of brass, steel or glass-filled nylon, each arm would normally be made of high tensile steel.

Each arm has a base portion 25 of part-cylindrical form. The part-cylindrical surface of the base portion 25 defines the outer surface thereof, whilst its inner surface is generally flat as indicated at 26. However this flat surface 26 is formed with a recess 27 which extends from the end of the base portion 25 which, in use, is innermost in the body: 11,, and is acted upon by the locking means 18, as will be described. As shown best in FIGS. 5 and 8 to 10, this recess is arcuate and of frusto-conical form. The outer surface of this part-cylindrical base portion 25 is formed with two grooves which are axially spaced therealong, and which extend around the whole of the arcuate outer surface. Nearest the end from which the recess extends, there is provided a semicircular groove 28. The other groove 29, is of rectangular cross-section for the part thereof which follows a short portion of the part-cylindrical outer surface of the base portion 25. However as shown in FIG. 12, opposite ends of the groove are formed by cutting away the base portion to provide a pair of parallel side surfaces 30 which are normal to the flat inner face 26. Finally from the end of the base portion 25 opposite to the end from which the recess 27 extends, there is an integral finger 31 which is generally L-shaped comprising a longer stem part 32, which has a flat inner surface aligned with and forming an extension of the flat surface 26, and a short grip part 33 extending at 90° to the stem part 32 in a direction away from the flat surface 26. As can be seen from FIG. 10, the length of the grip part 33 is such that if projected onto the end surface of the base portion 25 from which the finger 31 extends, it would terminate short of the outer arcuate boundary defined by the outer part-cylindrical surface of portion 25. As can be seen in FIG. 11, the cross-section of the stem part 32 is generally rectangular, but of slightly rounded form on its sides other than that which is aligned with the flat surface 26.

FIGS. 5 and 16 best show how a pair of arms are, in use, arranged back-to-back so that their respective grip parts 33 face in opposite directions respectively. With this arrangement it will be appreciated that when the two arms are placed together, the respective recesses 27 thereof effectively mate to form a composite conical recess. It will also be appreciated from these Figures that the material around which the groove 29 extends is shaped and sized so as to be received within the slot 23 of the washer 22 so that the two arms 24 can slide towards and away from each other on this washer, which, as mentioned, acts as a guide for said arms. It will be appreciated that the parts of the washer at respective opposite longitudinal sides of the slot 23 are received in the groove 29 so that the respective opposite inner faces of the slot 23 are in close sliding relation to the side surfaces 30. Moreover the front part of the groove 29 which is wholly arcuate, provides the outer surface of the material around which the groove 29 extends with a configuration which matches the inner curved end surface of the slot 23.

As shown in FIGS. 5 and 16, the two arms are thus linearly slidably mounted back-to-back on the washer 22 with the respective base portions 25 extending from one side thereof, and the respective L-shaped fingers 31 extending from the opposite side thereof. The arms are biased together by means of a resilient O-ring 35 received in the composite groove formed by the grooves 28 communicating when the arms are engaged together. When, as will be described, the arms are moved apart, the resiliency of the ring provides a restoring force on said arms which thus biasses them back into engagement. The movement of the arms is wholly linear, with no pivotting.

As shown schematically in FIG. 16, the retention assembly 20 is received in one end of the body 10 such that the fingers 31 extend through the hole 14 in the end wall 13 of the body, and also through the corresponding hole in the foam pad previously mentioned, if this is fitted. The outer diameter of the washer 22 is only slightly less than the internal diameter of the body 11, so that the retention assembly is a close fit therein.

The spacer 19 is in the form of a cylindrical ring which, like the washer 22 has an external diameter which is only slightly less than the internal diameter of the body 11. When received in the body 11, this spacer 19 rests on the side of the washer 22 at which the base portions 25 of the respective arms 24 extend, with the spacer surrounding said base portions 25 and extending axially therebeyond.

The washer 18a has an external diameter just less than the internal diameter of the body 11.

The locking means 18 can be a proprietary push button lock which has a cylindrical body 36, the outer diameter of which is, like the spacer 19, washer 18a and washer 22, only slightly less than the internal diameter of the body 11, so that it is a close sliding fit therein. Between the spacer 19 and the locking means 18, and engaging them both at its respective opposite sides, is the wavy washer 18a, the purpose of which will be explained hereinafter. From the end of the body 36 which engages the wavy washer 18a, there extends a conical operating part 37, which is specially produced to adapt the proprietary lock for use with the retention assembly 20 of this embodiment. This operating part 37 can be screw-threaded, or otherwise attached, to the end of a central shaft of the lock which extends axially out of this end surface of the body 36 when a spring-loaded plunger 38 at the opposite end of the body 36 is pushed inwardly against its spring, full inward movement of the plunger from its FIG. 1 position to its FIG. 3 position, causing the plunger automatically to be retained in place. Thus the locking means can be placed in a locked condition without the use of the key 21. As shown in FIGS. 5 and 16, the outer side of the body 36 has a cylindrical recess 39 therein, for reception of a small compression spring 40 and a peg 41. It is intended that in one method of assembly, the spring is held compressed by the peg as the locking means is received into the body 11, with the peg engaging the inner surface of the body 11 whilst the locking means is moved axially inwardly until it engages the washer 18a, whereupon it is then moved angularly, if necessary, until the peg is in alignment with the recess 17 in the interior surface of the body 11. When this position is reached, the spring 40 biases the peg or equivalent member into the recess 17, so that, as shown in FIG. 16, the peg lies across the interface between the inner surface of the body 11 and the outer surface of the body 36 so as to retain the body 11 and locking means 18 together. The washer provides biasing on the locking means to facilitate the correct axial insertion of the locking means to align the peg with the recess 17, and also prevents rattling of the assembly.

The relative dimensions of the locking means, the washer 18a, and the spacer 19 have the result that when the plunger 38 is in its unlocked position the conical operating part 37 is axially clear of the respective base portions 25 of the arms 24, so that such arms are biased together by the 0-ring 35, with the result that each arm is in the position shown in the upper part of FIG. 16, i.e. it is disposed centrally in the body 11, as shown in FIG. 2.

However if the plunger 38 is depressed so that it automatically locks in its FIG. 3 position, the plunger movement will cause the conical operating part 37 to extend axially so that it moves from the position shown in the upper half of FIG. 16 to the position shown in the lower half thereof, this movement causing the point of the operating part 37 to enter the composite conical recess formed together by the recesses 27 of the arms 24, continued axial movement of the part 37 causing its conical surface to engage with the respective inner generally complementary tapered surfaces of the recesses 27 so as to force the two arms 24 to move apart linearly along tie slot 23 of the washer 22 to the position shown in FIG. 5 for the two arms, and as shown in FIG. 16 for the arm illustrated in the lower half of that Figure. In this position the one arm will engage against the face 34 at the closed end of the slot whilst the other arm will move to almost the open end of the slot 23, both arm movements being against the bias provided by the O-ring 35. In a further embodiment, only one arm could slide, the other being fixed.

Accordingly this separation of the arms 24 results in a corresponding separation of the fingers 31, so that, as can again be seen from FIGS. 5 and 16, the grip parts 33 of the fingers 31 move apart.

As mentioned previously, the principal intended use for this security device is to secure computer apparatus, and in this regard FIGS. 14 and 15 illustrate the use of the device at an opening in a wall 42 of such a device. However it will be appreciated that this application is in no way exclusive in that the security device can be used with almost any article which requires protection against theft, it merely being necessary that a wall or equivalent of the article has an appropriate opening. In this regard it is to be noted that whilst previous prior art security devices could only be used with a generally rectangular slot, the device of the present invention can be used not only with a slot of this type, but also with an ordinary circular opening, and both examples are shown in FIGS. 14b and 15b, the opening being shown as a rectangular slot by the numeral 43, and as a circular opening by the numeral 44.

FIG. 14a shows the locking apparatus in position at the wall 42 with its arms together and its fingers 31 having been passed through the opening. FIG. 14b shows an end view for this arrangement with the fingers having been passed through the rectangular slot or the circular opening. Once the plunger 38 of the locking means 18 has been depressed, as described, and the arms 24 thus forced apart, the fingers move to the position shown in FIG. 15a so that, as shown in FIG. 15b, the grip parts 33 now lie behind respective parts of the wall 42 at opposite ends of the rectangular slot, or at diametrically opposed parts of the circular opening thereby firmly securing the locking apparatus to the article of which the wall 42 is part. The foam pad, if used, protects the area of the wall 42 around the hole from possible damage.

It is important to note that with the present invention there is a simple connection between the locking means 18 and the outer body 11 so that these components rotate together, and additionally that there is no connection in either the unlocked or locked state of the locking means between said locking means and the retention assembly, so that it is always possible for the body 11 to be rotated relative to the retention assembly, in order, for example, for the body to take up a position to suit the anchor cable 16. This facility is, moreover, provided simply, without the use of any complex structure or large number of components. An additional benefit is that with this arrangement it is not possible by gripping any part of the body 11 or locking means 18, for example by pliers, and applying a turning force, to release the ‘lock’ of the retention assembly, since, as mentioned, this is unconnected to either the locking means 18 or the body 11. It will be appreciated that rotation of the body, and thus the locking means will merely cause the conical operating part 37 to rotate within the facing recesses 27 without of course transmitting any force to the arms 24 which would weaken the attachment of the grip parts 33 at the opening in the wall 42. In an alternative arrangement, it could be that there was some connection between the locking means and the retention assembly in the unlocked state of the locking means 18, but not in the locked state.

FIGS. 17 to 23 illustrate a further embodiment of locking apparatus of the present invention. However this embodiment is quite similar to that described in relation to FIGS. 1 to 16 and merely differs in the form of a retention assembly, in particular in relation to the guiding and biasing of the arms thereof. Accordingly components and component parts of this second embodiment which are of the same form as with the first embodiment will be accorded the same numerals.

The main change with this second embodiment is the replacement of the guide washer 22 with a cylindrical bush 45 which mounts within and across it a pair of spaced parallel pins 46, each pin having its opposite ends received in respective parallel bores 47 in the bush 45, the respective pairs of aligned bores 47 being equi-spaced at respective opposite sides of a diameter of the bush 45, as best shown in FIG. 22. As shown in FIG. 17, this bush is received in the body 11 at the end thereof, in engagement with the end wall 13. Each arm 24 is provided with a pair of spaced parallel circular holes 48 therethrough for mounting each arm 24 on the two circular-section pins 46 for sliding movement therealong towards and away from each other in a similar manner as with the guide washer 22 previously described. Moreover in the outer part-cylindrical surface of the base portion 25 of each arm 24 there is a cylindrical recess 49 to receive one end of a compression spring 50, the other end of which is received in an aligned cylindrical recess 51 in the inner surface of the bush 45, the springs 50 thus providing a biasing force normally to move the two arms 24 together. As with the first embodiment, depression of the plunger 38 causes the operating part 37 to be received in the recesses 27 in the arms 24 respectively thereby forcing them apart against the biasing force of the springs 50, so that the arms 24 slide linearly apart along the pins 46 to the position shown in the lower part of FIG. 17 thereby again to move the grip parts 33 to lock in the opening in the wall 42 in the same way as previously described in relation to FIG. 15b. Again unlocking is by way of the key 21 onto the depressed plunger 38 which is thus turned and is released by its biasing spring.

1. A locking apparatus comprising a housing, locking means at least partly within the housing and secured thereto for angular movement therewith, retention means extending at least partly from the housing and being movable by operation of the locking means from a retracted state to an extended state, the arrangement being such that, in use, at least part of the retention means in said retracted state can be passed through an opening in an element, and the locking means then operated to move the retention means to said extended state, in which state the apparatus is attached to said element, and said housing and locking means are angularly movable together relative to said retention means.

2. A locking apparatus as claimed in claim 1, wherein said housing has means for attaching a security cable thereto.

3. A locking apparatus as claimed in claim 1 or claim 2, wherein the retention means are movable linearly.

4. A locking apparatus as claimed in claim 1 or claim 2, wherein the housing is an outer body and the retention means comprise two arms which are relatively movable towards and away from one another between said respective extended and retracted states, the arrangement being such that, in use, with said retention means in said retracted state the arms can be passed through said opening in the element, locking operation of said locking means then effecting relative movement apart of the arms to said extended state, in which said arms cannot pass back through said opening, so as to attach the apparatus to said element.

5. A locking apparatus as claimed in claim 4, wherein the movement of the arms is linear.

6. A locking apparatus as claimed in claim 4 or claim 5, wherein the retention means and part of the locking means have complementary tapered surfaces respectively which interengage during said locking operation to translate linear movement of said part of the locking means into linear movement at 90° thereto of at least one of said arms.

7. A locking apparatus as claimed in claim 6, wherein said part of the locking means is a conical element and said complementary surface of each arm is a part-conical surface of a recess therein, said recesses together forming a composite recess when the arms are biased together in the unlocked state of the locking means.

8. A locking apparatus as claimed in claim 7, wherein each arm, is linearly movable along a slot in a guide of the retention means,

9. A locking apparatus as claimed in claim 8, wherein each arm has respective groove portions in opposite sides of a base portion thereof, and respective portions of the guide at opposite sides of the slot are received in said groove portions.

10. A locking apparatus as claimed in claim 9, wherein the guide is a C-shaped washer.

11. A locking apparatus as claimed in any one of claims 7 to 10, wherein the biasing of the arms is by a O-ring received in a composite groove around the arms when they are together, the composite groove being formed by respective separate grooves in each arm.

12. A locking apparatus as claimed in any one of claims 8 to 10, wherein a spacer is disposed between the guide: and the locking means to space said conical element from said composite recess in the unlocked state of the locking means.

13. A locking apparatus as claimed in any one of claims 1 to 7, wherein each arm is linearly movable along an elongate guide element of the retention means.

14. A locking apparatus as claimed in claim 13, wherein said guide element is carried by a bush within which a base part of each arm is disposed.

15. A locking apparatus as claimed in claim 14, wherein two guide elements are provided in the form of parallel, spaced guide pins, the opposite ends of each guide pin being received in respective holes in said bush, and each guide pin extending through respective aligned holes in the arms.

16. A locking apparatus as claimed in claim 14 or claim 15, wherein for each arm a biasing means acts thereon to move it towards the other arm.

17. A locking apparatus as claimed in claim 16, wherein the biasing means is a compression spring acting between the bush and the arm, one end of the spring being received in a recess in the bush and its other end being received in a recess in the arm.

18. A locking apparatus as claimed in any one of the preceding claims, wherein the retention means include two hook-like members which are intended to be passed, in use, through said opening in said retracted state of the retention means, and, thereafter, in said extended state to engage part of the element around said opening upon attempted withdrawal, thereby to attach the apparatus to said element.

19. A locking apparatus as claimed in any one of claims 4 to 12, wherein each arm has a finger-like portion extending out of said housing, each finger-like portion terminating in a hook-like member which is intended to be passed, in use, through said opening in said retracted state of the retention means, and, thereafter in said extended state to engage part of the element around said opening upon attempted withdrawal, thereby to attach the apparatus to said element.

20. A locking apparatus as claimed in any one of the preceding claims, wherein said locking means requires a key to effect unlocking thereof, but not to effect locking.

21. A locking apparatus as claimed in claim 20, wherein locking of the locking means to move the retention means to said extended state is effected, in use, solely by depression of a plunger of the locking means.

22. A locking apparatus as claimed in claim 22, wherein the plunger automatically locks in place when depressed and is spring-loaded so as to return to its unlocked state when turned by said key.

23. A locking apparatus as claimed in any one of the preceding claims, wherein the locking means and the housing are secured together against relative rotation by spring-loaded detent means which extend across the interface between the outer surface of a body of the locking means and the inner surface of the housing in which the body of the locking means is received.
